(19) United States
(12) Patent Application Publication
(10) Pub. No.: US 2006/0285699 A1
(43) Pub. Date: Dec. 21, 2006

(54) Apparatus, system and method for capturing sound

(76) Inventor: Kenton Michael Fuqua, El Cajon, CA (US)

Correspondence Address: Benman, Brown & Williams, Ste. 2740, 2049 Century Park East, Los Angeles, CA, 90067, US

(21) Appl. No.: 11/450,749

(22) Filed: Jun. 9, 2006

Related U.S. Application Data
(63) Continuation-in-part of application No. 10/038,400, filed on Jan. 3, 2002.

(51) Int. Cl. H04R 3/00

(52) U.S. Cl. 381/92

(57) ABSTRACT

A sound capture apparatus with first and second omnidirectional acoustic transducers mounted at a separation distance to simulate a manner by which sound waves propagate around a human head. The apparatus also includes an arrangement for amplifying the output of each transducer. The amplifying arrangement is mounted within a housing in close proximity to the transducers. The amplifying arrangement provides output signals at line level.

### CROSS-REFERENCE TO RELATED APPLICATION

This Continuation-In-Part application claims the benefit of related U.S. non-provisional patent application Ser. No. 10/038,400, entitled “Apparatus, System and Method For Capturing Sound”, filed on Jan. 3, 2002 by K. M. Fuqua.

### BACKGROUND OF THE INVENTION

1. Field of the Invention

The present invention relates to audio systems. More specifically, the present invention relates to systems and techniques for capturing sound.

2. Description of the Related Art

Sound capture devices convert acoustical sound pressure waves into electrical signals. Examples of conventional sound capture devices include microphones and other types of acoustical transducers where a transducer produces an electrical current or voltage in response to a received sound pressure wave.

Sound capture devices are used in variety of systems and devices in areas such as communication, live concerts, sound recording, sound amplification and broadcasting, television, film, surveillance and sonar. In most applications, it is advantageous to capture the sound with the highest possible accuracy and without noise. For example, in applications involving the recording or amplification of music, great efforts are typically taken to properly position microphones. Further, a protected sound booth is often utilized to reduce noise due to external sources and to otherwise maintain a high signal to noise ratio of the captured sound. Other examples of applications requiring accurate capture of sound include communication and voice recognition systems. Although, it is often difficult to control the environment in these systems, the quality of the captured sound can be improved by using a sound capture device with the appropriate characteristics and sound processing the captured signal.

Conventional sound capture devices are limited in performance and are often the “weakest link” in many recording, communication and other systems utilizing a sound capture device. Some techniques can be used to improve the quality of a captured signal by, for example, filtering, amplifying, equalizing, or otherwise processing an existing signal. Performance of the system, however, is still limited by the quality of the original captured sound signal.

Important performance characteristics of a sound capture device include characteristics related to frequency response of the sound capture device, the signal-to-noise ratio of the captured signal and phase information of the captured signal. The frequency response of the sound capture device affects the relative amplitude of the sound signal at different frequencies. The signal to noise ratio is the ratio of amplitude of the desired signal as compared to the level of the noise. Although noise may exist from external sources, noise produced by the sound capture device and other system components should be minimized.

Conventional microphones are very limited in performance related to phase information. In natural human hearing, phase information is the difference in the time of arrival of a sound wave at the left ear versus at the right ear. This difference enables us to perceive the three-dimensional location of a sound source. With conventional microphones, phase information is simulated by one of two methods. Neither method is effective in capturing genuine, full phase information.

In one method, the signals from multiple microphones are positioned left to right via pan pots on an audio mixing board. In this method, the sound sources are typically close-miked (i.e., each microphone is positioned very close to an individual sound source). This method recreates a choppy, artificial impression of spatial location of sound sources, lacking the resonances that result from the actual positions of multiple sound sources.

In the second method, two microphones are positioned close to one another at different angles in order to capture different directions of sound. Positioning methods such as XY, Blumlein, MS, NOS, ORTF, etc., are used to recreate the impression of a left-to-right “sound stage.” In this method, the microphones are typically located at some distance from the sound sources (i.e., “ambient-miked”). The sound information thus captured is similar to natural phase information, but the method inevitably creates gaps where sound sources and resonances are located off-axis or in “dead zones” relative to the pick-up fields of the microphones.

Therefore there is need for an efficient apparatus, system and method for maximizing the signal-to-noise ratio and amount of phase information of a captured sound signal when converting sound energy to an electrical signal.

### SUMMARY OF THE INVENTION

The need in the art is addressed by the sound capture apparatus of the present invention. In the illustrative embodiment the apparatus includes first and second omnidirectional acoustic transducers and an arrangement for amplifying the output of each transducer.

In the illustrative embodiment each of the transducers are mounted at a separation distance to simulate a manner by which sound waves propagate around a human head. The amplifying arrangement is mounted within a housing in close proximity to the transducers. The amplifying arrangement provides output signals at line level.

In the best mode, the amplifying arrangement is implemented with vacuum tube technology.

### BRIEF DESCRIPTION OF THE DRAWINGS

FIG. 1 is a perspective view of a sound capture apparatus implemented in accordance with an illustrative embodiment of the present teachings.

FIG. 2 is a top view of the sound capture apparatus of FIG. 1.

FIG. 3 is a block diagram of a single channel of the sound capture apparatus of FIG. 1.

FIG. 4 is a block diagram of a sound capture device implemented in accordance with the present teachings and used in a recording system.

### DESCRIPTION OF THE INVENTION

Illustrative embodiments and exemplary applications will now be described with reference to the accompanying drawings to disclose the advantageous teachings of the present invention.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

In an exemplary embodiment of the invention, first and second omni-directional transducers convert sound into an electrical signal that is amplified by first and second amplifiers co-located with and coupled to a respective one of the transducers. The resulting amplified electrical signals are transmitted on signal conductors in a transmission interface, such as a transmission interface cable or pair of cables, while power is supplied to the amplifiers and the transducers through separate supply conductors in the transmission interface. Other features of the exemplary embodiment include short transmission paths from the transducers to the amplifiers and a multiple stage amplifier. Various other embodiments may incorporate some or all of the features discussed herein in addition to other features not explicitly emphasized.

The inventive sound capture apparatus offers several advantages over conventional microphones. For example, as discussed more fully below, phase information is accurately captured and retained in the inventive sound capture system by first and second omnidirectional transducers in an inventive stereo array. In the exemplary embodiment the two omnidirectional transducers are spaced by a separation distance in accordance with the manner by which sound waves propagate around a human head. The transducers are positioned such that the separation distance simulates the time delay experienced from the front of a human head to the ears when the head is facing the sound source and therefore, to simulate the phase differential as experienced at the ears. Further, the transducers can be angled toward the sound source to simulate the sound reception of human ears. This adds a unique dimensionality or color to the sound which may be output or stored for playback.

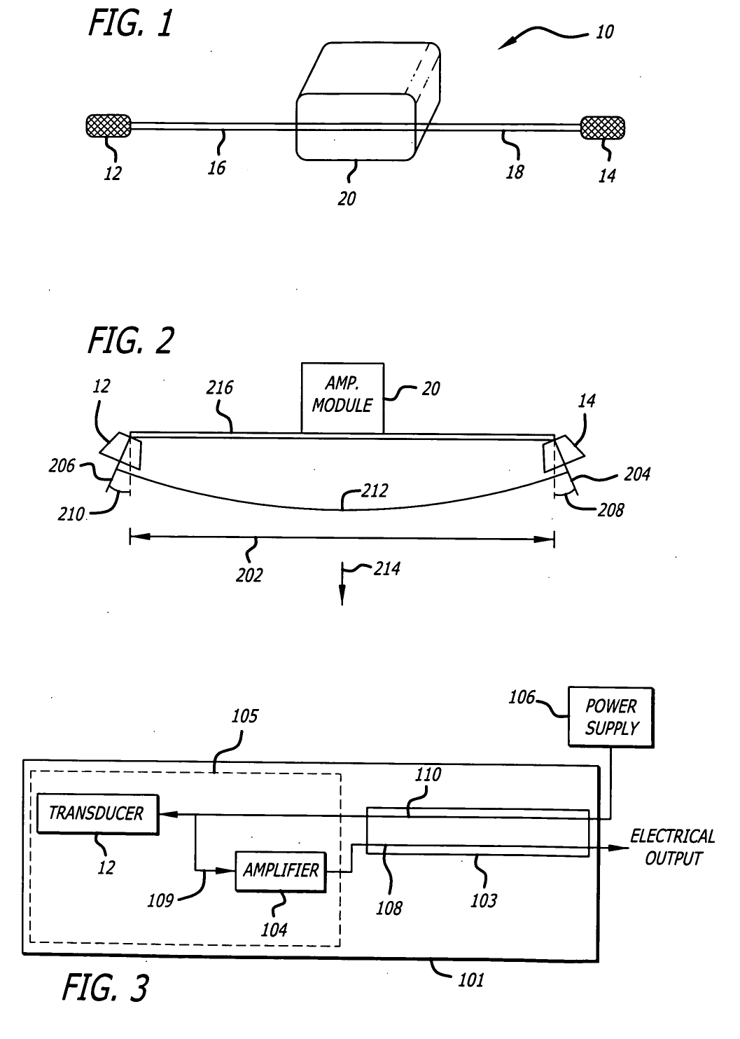

FIG. 1 is a perspective view of a sound capture apparatus implemented in accordance with an illustrative embodiment of the present teachings. The sound capture system 10 can be utilized in a variety of applications including music and sound recording, communications, broadcasting, sound amplification, voice recognition systems, sonar and other applications where sound is converted from a sound pressure wave to an electrical signal. As shown in FIG. 1, the apparatus 10 includes first and second high quality omnidirectional acoustic transducers 12 and 14. The transducers 12 and 14 are disposed on first and second support arms 16 and 18 respectively. The support arms 16 and 18 may comprise a single rod coupled to the amplifier module 20. In the best mode, the distance between the transducers is 12 inches. The support arms are coupled electrically and, in the illustrative embodiment—mechanically, to an amplification module 20 in which first and second preamplifiers (not shown) are disposed, one for each transducer.

The transducers 12 and 14 are omnidirectional and produce a high quality electrical signal in response to sound. The transducers 12 and 14 may be any one of several types of transducers or combinations of omnidirectional transducers. Examples of suitable transducers include condenser, dynamic, and electret elements or microphones. The transducers 12 and 14 may be used to provide a mono, binaural, stereo, multiple channel or a phased array electrical signal. The relationship between the electrical signal and received sound signal may or may not be linear depending on the type of transducer, the level of sound signal and operable frequency range.

The transducers 12 and 14 are mounted to a support arm 216 and positioned at a separation distance 202 in accordance with sound reception at human ears on a human head facing a sound source. This is illustrated in FIG. 2.

FIG. 2 is a top view of the sound capture apparatus of FIG. 1. As shown in FIG. 2, the support arm 216 can have a variety of shapes and sizes. In the exemplary embodiment, the support arm 216 has a width less than ¼ of an inch and a shape that minimized interference with the sound being captured. Also, the support arm 216 can be eliminated in some situations.

The separation distance 202 is selected to simulate sound travel to human ears around a human head facing a sound source. The direction of the sound source relative to the sound capture module 105 is indicated with arrow 214 in FIG. 2. For an average person, the linear distance through the skull between the two ears is approximately 7 to 8 inches. A substantial portion of the sound energy of a sound wave incident on the human head does not travel through the head and travels along the contour of the skull to the ears. For sound waves traveling toward the head at any angle up to 180 degrees from the direction the head is facing (module axis) 214, the effective distance between the two ears that the sound waves must travel is approximately equal to the radius of the head multiplied by n (pi). Accordingly, in the exemplary embodiment, the separation distance 202 between the two transducers 12, 14 is 12 inches. In certain instances a separation distance 202 anywhere between 10 and 14 inches is appropriate. In other instances, a separation distance 202 between 11 and 13 inches is appropriate.

Each of the transducers 12 and 14 is positioned at an angle 208, 210 to the axis 214 from the center of the sound capture module 105 to the sound source producing the captured sound. The sound capture module 105, therefore, is positioned such that a line connecting the two transducers 12, 14 is perpendicular to the direction a human head would face to listen to the sound. Each of the transducers 12 and 14 has an axis 204, 206 along the main lobe of a sound reception pattern of the transducers 12 and 14. The angle 212 between the transducer axis 204, 206 is chosen to simulate the sound reception at human ears. In the exemplary embodiment, the angles 208, 210 from the each transducer axis 204, 206 to the module axis 214 are both approximately 15 degrees. The angle 212 between the two-transducer axis 204, 206 is therefore, approximately 30 degrees in the exemplary embodiment. In certain circumstances, the angles 12, 14, 210 may have different values. Also, in certain circumstances the angles 208, 210 may be between 5 and 25 degrees. In other circumstances, the angles 208, 210 are anywhere between 10 and 20 degrees.

Positioning the transducers at the angle 212 allows better off-axis performance than conventional microphones. The angle 212 may have any value including angles 212 from zero to ninety degrees. In addition, the specific angle 212 or angles 208, 210 can be adjusted to provide various sound qualities.

The positioning of the transducers 12, 14 allows sound capture that retains the phase information of the sound signal. In recording applications, the sound signal is more accurately reproduced during playback due to the retention of phase information as compared to conventional recording systems and microphones. A reproduced sound signal from the recorded sound signal includes phase angle information and imaging at the same ratio as experienced by a person listening to the original sound signal, live. The result is a more realistic reproduction of recorded sound than is possible with conventional microphone devices.

The transducers 12, 14 are connected to the amplifier 104 through the internal signal conductor 109. In the exemplary embodiment, the amplifier 104 includes circuitry for each channel and, therefore, includes a set of amplification stages for each of the transducers 12 and 14. Each transducer and associated amplifier form a sound capture module 105 that is connected to a transmission interface 103. The transmission interface 103 provides transmission paths for outgoing electrical signals from the sound capture module 105 and for incoming power to the sound capture module 105. The transmission interface 103 includes at least one signal conductor 108 and one supply conductor 110 and may include several other conductors, shields, or insulation. The transmission interface 103 can be any type of cable, wire, transmission line or connector that includes at least one signal conductor and at least one supply conductor. The transmission interface 103 may include a single housing or cable that encases the signal conductor 108 and the supply conductor 110. In the exemplary embodiment, however, the transmission interface 103 includes a supply cable and a signal cable where the supply cable includes two supply conductors 110 and a common conductor and the signal cable includes two signal conductors 108 as well as a grounded shield.

FIG. 3 is a block diagram of a single channel of the sound capture apparatus of FIG. 1. In the exemplary embodiment, each transducer is part of a single channel of 101 of the sound capture device. Each channel 101 is an integrated unit including the sound capture module 105 and transmission interface 103. In certain circumstances, however, the sound capture module 105 may be connected to the transmission interface 103 through a connector allowing the sound capture module 105 to be disconnected from the transmission interface 103.

The electrical signal produced at the output of each of the transducers 12 and 14 is transmitted through an internal conductor 109 to a preamplifier 104. The internal conductor 109 is as short as possible (e.g., 7 inches or less) in the exemplary embodiment and may comprise a short section of conductor or trace on a printed circuit board. Another example of a suitable internal conductor 109 includes a direct connection between the contacts comprising the electrical signal output of the transducer to the first component of the amplifier 104. Other examples include short lengths of cable, wire, and conductive tape or ribbon.

The electrical signal is received at an amplifier input of an amplifier 104 and amplified to produce an amplified electrical signal. In the exemplary embodiment, the amplifier includes multiple amplification stages. A suitable configuration of the amplifier includes the use of two stages. Any number of amplification stages may be used, where the number of amplification stages depends on factors such as the amplitude of the electrical signal, the characteristics of each amplification stage, the characteristics of the transmission interface 103 and the desired amplitude of the amplified electrical signal.

The amplified electrical signal is transmitted through the transmission interface 103 on the signal conductor 108. Hence, the electrical signal from each of the transducers 12 and 14 is amplified by a separate channel amplifier and transmitted through a separate signal conductor 108. The transmission interface 103 provides a connection to the desired destination of the amplified electrical signal. If the sound capture device 101 is used in a musical recording system, for example, the transmission interface 103 is connected to a ‘line level’ input of the recording equipment that may include an equalizer, filter, analog to digital (A/D) converter, or other signal processing equipment as well as analog or digital recorders. In applications such as recording studios and live concerts, a suitable transmission interface 103 includes several feet of shielded signal cable that includes the supply conductor 108 and a separate supply cable that includes the supply conductor 110. Where the sound capture device 101 is used in a communication system, the transmission interface 103 may have a length on the order of a few inches or less and may include two or more wires connected to audio processing or other circuitry in a communication device.

Each microphone is powered by a completely discrete, very low-noise (e.g., approx. 120 dB) power supply. The power supply 106 provides electrical power to the transducers 12 and 14 and the amplifier 104 through the transmission interface 103. In the exemplary embodiment, the power supply 106 is a direct current (DC), low noise power supply that provides a positive supply voltage regulated to approximately 14 volts and a negative supply voltage regulated to approximately −14 volts relative to a common voltage such as ground. As discussed above, the transmission interface 103 includes two supply conductors 110 as well as a common conductor in the exemplary embodiment. The positive supply voltage is provided to the transducer module 105 through one of the supply conductors 110 and the negative supply voltage is provided through the other supply conductor 110. With separate cables providing power from the power supply to each microphone transducer, power is not run along the same feed as the sound signal, that is, the power is not phantom power.

Some of the advantages of the sound capture device 101 over conventional microphones, therefore, result from the co-location of the transducers 12 and 14 and the associated amplifiers. By utilizing internal conductors 109 having a relatively short length, less noise is introduced to the electrical signal. Further, a relatively short length minimizes signal loss from the transducers 12 and 14 to the associated amplifiers 104 and 105. Most conventional systems, particularly music recording systems, do not amplify the electrical signal produced by the microphone until after a relatively long transmission path from the microphone resulting in the amplification of a weak and noisy signal. Accordingly, co-location of the amplifiers to the transducers 12 and 14 minimizes the length of the transmission path between the transducers 12 and 14 and the amplifiers 104 and 105.

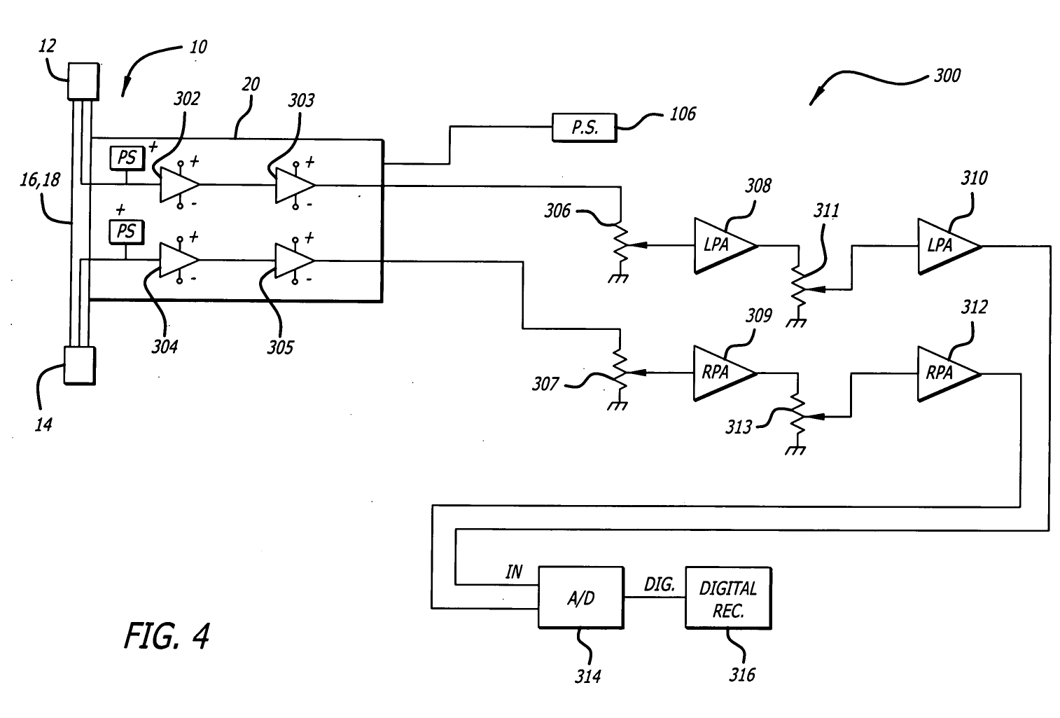

FIG. 4 is a block diagram of a sound capture device 10 implemented in accordance with the present teachings and used in a digital recording system. Two transducers 12, 14 in the sound capture module 105 produce electrical signals in accordance with received sound pressure waves. The system 300 includes components to process and record two channels such as a left channel and right channel. In the exemplary embodiment, therefore, the amplifier includes two channel amplifiers 302 and 304. One channel amplifier 302 is used for a left channel and the other channel amplifier 304 is used for a right channel. Any number of channel amplifiers, e.g. 303 and 305, can be used without departing from the scope of the present teachings.

Each channel amplifier amplifies the electrical signal produced by one of the transducers 12, 14. The channel amplifiers amplify the electrical signals to a line level voltage, in the illustrative embodiment, a voltage on the order of 2-6 volts average RMS (Root Mean Square). As is known in the art, relative to a typical mic-level output, line-level output is less subject to degradation of frequencies and phase angles and interference as signal travels over output cables.

The resulting amplified electrical signals are coupled to variable resistors 306 and 307. These resistors provide a mechanism for adjusting the amplitude of each amplified signal received from each of the channel amplifiers. Those skilled in the art will recognize the various types of volume controls that can be used. For example, a single potentiometer can be used as a volume control for both channels.

Line-level amplifiers 308 and 309 amplify the amplitude adjusted electrical signal in each channel to produce a master electrical signal. The master electrical signal can be further adjusted by master volume control potentiometers 311 and 313 in conjunction with amplifiers 310 and 312. Thus, as depicted in FIG. 4, each microphone has two two-stage amplifier circuits located within approximately 8″ of the microphone capsules and within the housing 20.

In the embodiment of FIG. 3, the outputs of the amplifiers 310 and 312 are input to a digital recorder via an analog to digital converter 314. However, in practice, the output of the preamplifiers housed in the module 20 may be output directly to speakers, analog amplifiers or other circuits without departing from the scope of the present teachings.

The optimum employment of the present invention involves a recording technique that combines aspects of both close and ambient microphone placement. The microphone will typically be placed further away from the sound source than in close miking, but closer to the source than in ambient miking. These distances will vary with the volume and number of sound sources and the resonant qualities of the recording space.

Thus, the present invention has been described herein with reference to a particular embodiment for a particular application. Those having ordinary skill in the art and access to the present teachings will recognize additional modifications, applications and embodiments within the scope thereof. For example, the preamplifiers may be implemented with vacuum tubes or with solid-state technology. In a vacuum tube implementation, there might be one vacuum tube per transducer.

It is therefore intended by the appended claims to cover any and all such applications, modifications and embodiments within the scope of the present invention.

Accordingly,

What is claimed is:

1. A sound capture device comprising:
first and second omnidirectional acoustic transducers and
means for amplifying the output of each transducer.

2. The invention of claim 1 wherein said transducers are mounted at a separation distance to simulate a manner by which sound waves propagate around a human head.

3. The invention of claim 1 wherein said means for amplifying is mounted within a housing.

4. The invention of claim 3 wherein said means for amplifying is mounted in close proximity to said transducers.

5. The invention of claim 1 wherein said means for amplifying provides an output signal at line level.

6. The invention of claim 1 wherein said means for amplifying includes at least one vacuum tube.

7. A sound capture device comprising:
first and second omnidirectional acoustic transducers and
means for amplifying the output of each transducer.

8. The invention of claim 7 wherein said transducers are mounted at a separation distance to simulate a manner by which sound waves propagate around a human head.

9. The invention of claim 7 wherein said means for amplifying is mounted within a housing.

10. The invention of claim 9 wherein said means for amplifying is mounted in close proximity to said transducers.

11. The invention of claim 7 wherein said means for amplifying provides an output signal at line level.

12. The invention of claim 7 wherein said means for amplifying includes at least one vacuum tube.

13. A sound capture device comprising:
first and second omnidirectional acoustic transducers mounted at a separation distance to simulate a manner by which sound waves propagate around a human head and
means mounted within a housing in close proximity to said transducers for amplifying the output of each transducer and providing first and second output signals at line level.

14. A sound capture method including the steps of:
providing first and second omnidirectional acoustic transducers and
amplifying the output of each transducer.
